(19) United States
(12) Patent Application Publication
(10) Pub. No.: US 2025/0124277 A1
(43) Pub. Date: Apr. 17, 2025

(54) SYSTEMS AND METHODS FOR MODEL PERFORMANCE VALIDATION FOR CLASSIFICATION MODELS BASED ON DYNAMICALLY GENERATED INPUTS

(71) Applicant: Capital One Services, LLC, McLean, VA (US)

(72) Inventors: Terence MAN, McLean, VA (US); Kia NAZIRI, McLean, VA (US)

(73) Assignee: Capital One Services, LLC, McLean, VA (US)

(21) Appl. No.: 18/488,137

(22) Filed: Oct. 17, 2023

(51) Int. Cl. G06N 3/08

(52) U.S. Cl. CPC G06N 3/08

(57) ABSTRACT

Systems and methods for model performance validation for classification models based on dynamically generated inputs are disclosed herein. In some aspects, the system may receive a first dataset. The system may provide the first dataset and a first output to a first validation model to generate a first validation metric. The system may generate a first plurality of datasets. The system may generate a plurality of outputs based on the first plurality of datasets. The system may provide the first plurality of datasets and the plurality of outputs to a second validation model and generate a second validation metric based on the second validation model. The system may generate an evaluation metric and generate updated model parameters for the first validation model. The system may generate an updated first validation model.

### SUMMARY

Methods and systems are described herein for dynamic validation of classification models in a manner that is consistent with model validation protocols and technical requirements for batch-generated input data. For example, classification models may rely on input data compiled from various sources, and such data may be transformed or formatted according to security or data storage constraints. The system disclosed herein enables dynamic model validation for these classification models based on raw, untransformed input data, thereby enabling more efficient updates and improvements to the underlying classification model.

Conventional machine learning models are able to generate classifications and make decisions on the basis of input data. For example, artificial neural networks may handle incoming data differently based on an associated classification—data that is determined to be valid may be separated from data that is determined to be invalid. However, such classification models may rely on information or data that is processed, cleaned, cross-referenced, or verified for security or reliability purposes. As such, testing or validating and subsequently updating such classification models can be time-consuming, as new test data for the models may require transformation to formats acceptable to the classification model prior to validating the model's performance through a validation algorithm. Furthermore, validation of classification models in conventional systems may rely on batch-processed data, such as data that has been compiled over time and corresponding to various types of input data, in order to validate the overall performance of the classification model. As such, conventional systems may not enable dynamic updating of model performance as input data is provided in real time. Validation of classification models in conventional systems may be inefficient as a result and, subsequently, updates to the classification models may be slow to adapt to any changes in the nature of input data over time.

To overcome these technical deficiencies in conventional model validation for classification models, the methods and systems disclosed herein enable generation of a first validation metric for a classification model that accepts unprocessed data of a first data format, and a second validation metric for a classification model that accepts processed or transformed data of a second data format. Furthermore, the system may generate an evaluation metric based on the real-time model validations in order to improve the batch-tested models. By doing so, the system enables iterative, efficient testing of raw datasets while still maintaining consistency with the batch-data validation, thereby enabling improvements to the accuracy of the classification models for a diverse set of input data. Thus, the system may produce model evaluation metrics that are consistent with the batch-level model validation procedure. Based on these model evaluation metrics, the system may train or generate new model parameters for the classification model on the basis of raw input data, thereby enabling more efficient classification model training.

In some aspects, the system may receive a first dataset. The first dataset may include information in a first data format corresponding to a first user. As an illustrative example, the system may receive information relating to a user requesting access to a secure cloud storage system, including user-related information, such as credentials, geographic location, user activity information, and/or device information. By receiving such information, the system may obtain information useful for the evaluation of the user's identity or eligibility for access to the cloud storage system.

In some aspects, the system may input the first dataset into a classification model and generate a first validation metric for the classification model based on this raw data. For example, the system may provide the first dataset to the classification model and generate a first output, where the first output includes first evaluation data associated with the first user. The system may provide the first dataset and the first output to a first validation model in order to generate a first validation metric. For example, the system may generate an indication of a user's eligibility for access to the cloud storage system (e.g., an authentication status) based on evaluating user credential information within the first dataset. The system can provide this indication to a validation model that may validate whether the predicted authentication status matches a ground-truth authentication status, such as a previously determined status. Based on this indication, the validation model may output a metric that indicates the accuracy or performance of the classification model in evaluating the first dataset corresponding to the user. By doing so, the system may evaluate the ability of the classification model to generate predictions based on dynamically received input data, even if such data is yet to be processed or transformed.

In some aspects, the system may generate a first plurality of datasets based on transforming raw data to a second data format. For example, the system may generate a first plurality of datasets, wherein the first plurality of datasets includes representations of the first dataset in a second data format and a second plurality of datasets corresponding to the plurality of users. As an illustrative example, the system may leverage data corresponding to more than one user for validation of the classification model's performance. Furthermore, the classification model may require a transformation of raw input data to a more secure or reliable format (e.g., the second data format); thus, the system may obtain or prepare the information within the users' data into this second format for further processing.

In some aspects, the system may generate outputs based on this transformed data. For example, the system may generate, from the classification model, a plurality of outputs based on the first plurality of datasets, wherein each output of the plurality of outputs includes corresponding data of a corresponding user of the plurality of users. As an illustrative example, the system may generate predicted authentication statuses for many users corresponding to the credential information within the first plurality of datasets, where this credential information is in a data format with, for example, security or formatting constraints. By generating these authentication statuses, the system may perform validation based on high-quality data, as well as data processed in a batch form (e.g., including data associated with multiple users), thereby providing higher-quality classification model validation than for the raw data.

In some aspects, the system may provide the outputs to a second validation model in order to generate a second validation metric. For example, the system may provide the first plurality of datasets and the plurality of outputs to a second validation model. Based on the second validation model, the system may generate a second validation metric for the classification model. For example, the system may generate an evaluation of the classification model's performance based on the user data of the second data format, as well as the corresponding predicted authentication statuses. By doing so, the system may utilize the second validation model to evaluate the classification model using higher-quality data than for the first validation model, thereby providing information that enables improvements to the first validation model's evaluation of the classification model.

In some aspects, the system may generate an evaluation metric for the first validation model based on differences in the validation of the classification model between the first validation model and the second validation model. For example, the system may generate an evaluation metric of the first validation model with respect to the second validation model based on a comparison between the first validation metric and the second validation metric. As an illustrative example, the system may determine that the first validation model poorly captures any issues with the classification model, for example, due to differences in the formatting or quality of the input data. As such, the system may determine that the first validation model may require an update to its algorithm for determining the performance of the classification model.

In some aspects, the system may generate updated model parameters for the validation model based on the evaluation metric, and update the first validation model accordingly. For example, the system may, based on the evaluation metric, generate a plurality of updated model parameters for the first validation model. The system may generate an updated first validation model based on the plurality of updated model parameters. As an illustrative example, the system may modify a version of the classification model used such that the classification model uses input data differently (e.g., by weighting different portions of the input data differently, or performing intermediate operations on the input data) for processing, thereby improving the functioning of the first validation model such that the model is consistent with the second validation model and the high-quality version of the classification model. Thus, the system enables improved validation of the classification model based on dynamically received input data. By doing so, the system may improve the quality of validation of the classification model based on unprocessed or untransformed data, thereby improving the efficiency of improvements to the classification model.

Various other aspects, features, and advantages of the invention will be apparent through the detailed description of the invention and the drawings attached hereto. It is also to be understood that both the foregoing general description and the following detailed description are examples and are not restrictive of the scope of the invention. As used in the specification and in the claims, the singular forms of “a,” “an,” and “the” include plural referents unless the context clearly dictates otherwise. In addition, as used in the specification and the claims, the term “or” means “and/or” unless the context clearly dictates otherwise. Additionally, as used in the specification, “a portion” refers to a part of, or the entirety of (i.e., the entire portion), a given item (e.g., data) unless the context clearly dictates otherwise.

### BRIEF DESCRIPTION OF THE DRAWINGS

FIG. 1A shows an illustrative diagram of an input dataset to a classification model that is validated for model performance, in accordance with one or more embodiments.

FIG. 1B shows an illustrative diagram of a flowchart for improving classification model validation using dynamically received input data, in accordance with one or more embodiments.

FIG. 1C shows an illustrative diagram of data transformation rules for generating datasets of a second data format from datasets of a first data format, in accordance with one or more embodiments.

FIG. 2 shows an illustrative diagram of a display of a result of the classification model based on input user data, in accordance with one or more embodiments.

FIG. 3 shows illustrative components for a system used to perform model validation based on dynamically received input data, in accordance with one or more embodiments.

FIG. 4 shows a flowchart of the steps involved in improving model validation based on dynamically received input data based on model performance from batch-produced inputs, in accordance with one or more embodiments.

### DETAILED DESCRIPTION

In the following description, for the purposes of explanation, numerous specific details are set forth in order to provide a thorough understanding of the embodiments of the invention. It will be appreciated, however, by those having skill in the art that the embodiments of the invention may be practiced without these specific details or with an equivalent arrangement. In other cases, well-known structures and devices are shown in block diagram form in order to avoid unnecessarily obscuring the embodiments of the invention.

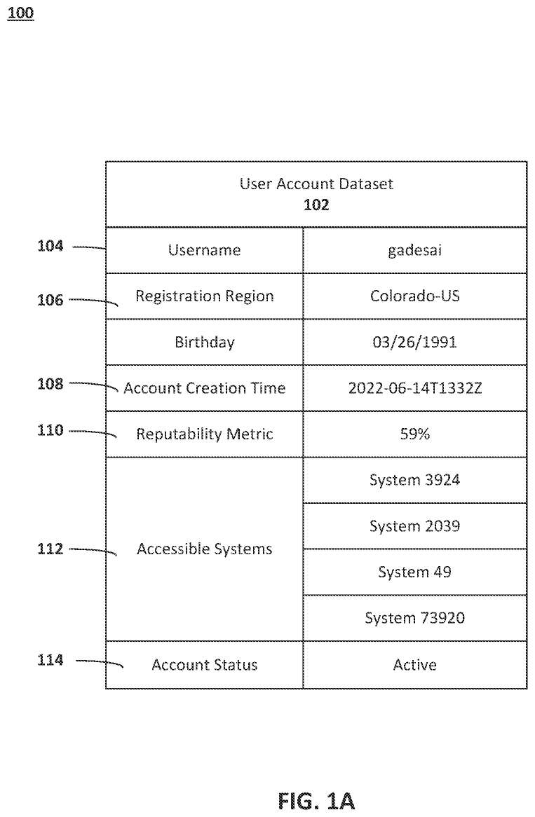

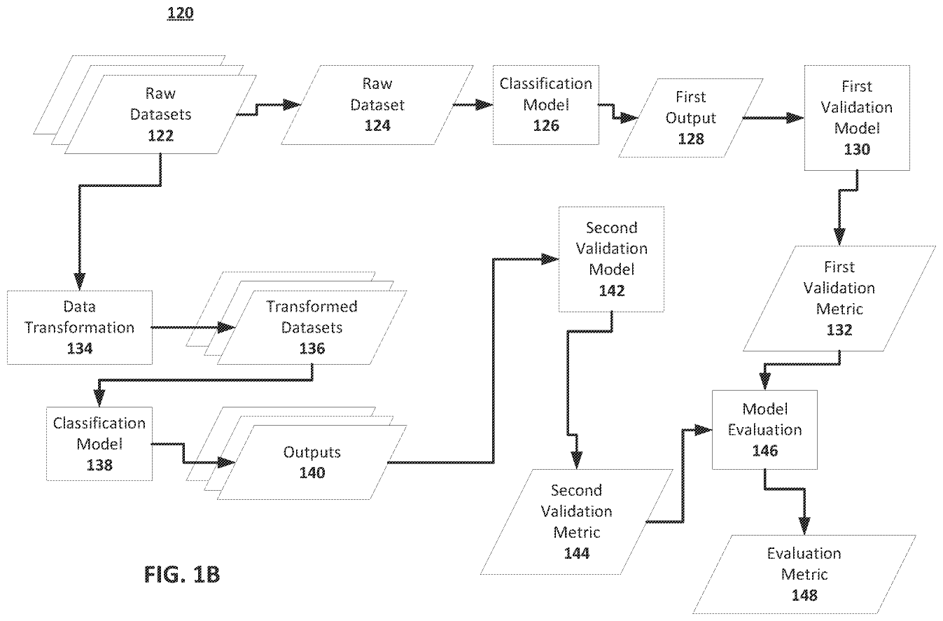

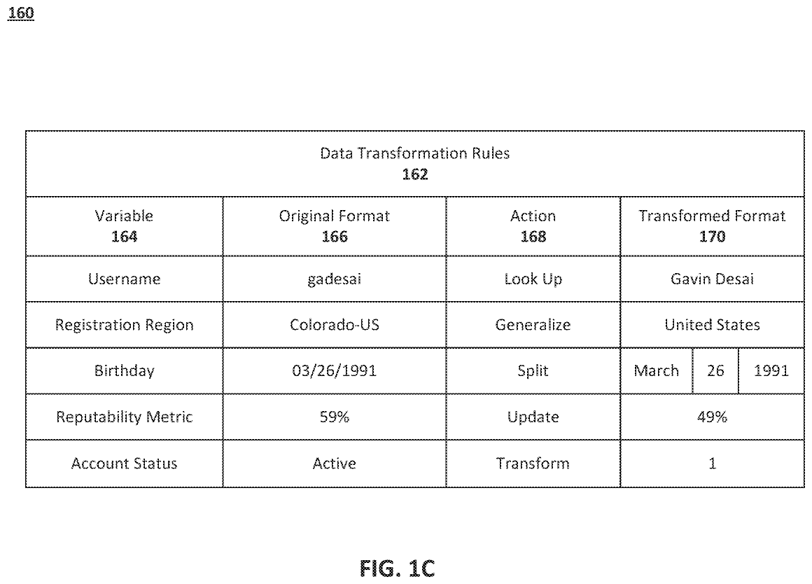

FIG. 1A shows an illustrative diagram of an input dataset to a classification model that is validated for model performance, in accordance with one or more embodiments. For example, dataset 100 may include user account dataset 102, corresponding to information relating to a user's account within a cloud storage system. For example, the dataset may include username 104, registration region 106, account creation time 108, reputability metric 110, accessible systems 112, and/or account status 114. By including information relating to a user, a classification model may utilize such data to evaluate the user, such as for determining user authentication or permission to use the system.

The system may receive, as input to the classification model, a dataset, such as user account dataset 102. In some embodiments, a dataset may include information relating to a user in a data format, such as information relating to the identity of a user (e.g., username 104 or a birthday), a region or location associated with the user (e.g., a location, or registration region 106), information relating to the user's reputation (e.g., reputability metric 110, or a credit score), and/or resources or systems to which the user has had access in the past (e.g., accessible systems 112, or previously accessed lines of credit). In some embodiments, the dataset may include information relating to the validity of a user account, such as account status 114. By receiving information relating to the user, the system obtains enough data for evaluation of the user. For example, the system may evaluate whether to provide access to a particular requested resource or system to the user. In some embodiments, the dataset may include information relating to an actual authentication status of the user, such as an authentication indicator (e.g., a ground-truth indication of whether the user permission has been granted on the basis of information within the dataset). By doing so, the system enables training and validation of automated evaluations of the user data within the dataset.

In some embodiments, the dataset may be specified in a data format. In some embodiments, data formats may include filetype formats (e.g., text, image, video, or other filetype standards). Alternatively or additionally, data formats may specify fields or types of data to be included within a given dataset. For example, a first data format may specify that a dataset should include a birthday, a registration region, or a reputability metric, with a certain type or range of values for each specified field. For example, a first data format may specify that birthdays should be represented in a “MM/DD/YYYY” format, as shown in FIG. 1A within user account dataset 102. In some embodiments, the data format may not specify any requirements or structures. For example, a data format may include unformatted information, such as from raw data produced dynamically from a variety of sources. Machine learning, validation, or classification models may request or require that datasets be provided in a particular file format therein. For example, some file formats may include security constraints or formatting requirements, as described below in relation to FIG. 1C. Because converting or transforming data into a particular data format may be time-consuming, the system disclosed herein enables model validation to occur with unformatted or efficiently formatted data, thereby improving the quality of model validation and subsequent model updates.

In some embodiments, a dataset may include a set of values corresponding to a set of variables. As an illustrative example, variables may include attributes indicated by fields within the dataset, such as a birthday, a username, or a time of account creation. As an illustrative example, a variable may include a full birthday, including the month, day, and year. Additionally or alternatively, variables may include the month, day, and year themselves, respectively. In some embodiments, the system may modify the variables in the dataset to generate another format for the dataset. For example, the system may generate new variables corresponding to variables originally within the dataset (e.g., by splitting a birthday into its component month, day, and year). Variables may be associated with values themselves. For example, account status 114 may be indicated by a value of 0 or 1 depending on whether the account is disabled or active. By tracking variables within the dataset and corresponding values, the system may generate or transform data between data formats as needed for classification model use and validation.

In some embodiments, the system may validate variables in order to generate validation statuses. For example, a validation status may include an indication of the validity of a value associated with a variable. As an example, a validation status may include a confirmation that username 104 associated with user account dataset 102 is valid and indeed associated with the user account dataset. In some embodiments, the system may reference a database and compare values associated with variables with respective values in the database to validate these values. In the case of an invalid or false value, the system may replace the value with a corresponding valid value (e.g., as determined by looking up a value for a corresponding variable within the database). By generating validation statuses, the system may ensure the validity and security of the dataset, thereby preventing malicious or false submissions. As such, the system enables accurate evaluation of user permissions on the basis of user data.

In some embodiments, datasets may include user activity data. User activity data may include information associated with a user's previous activities. For example, user activity data may include a log or an account of user actions, such as a log of previous actions carried out by the user within the user account. Additionally or alternatively, user activity data may include activities associated with a bank or credit card account, or other transaction-related activity. For example, user activity data may include previous credit card or loan statements and associated payments made by the user. In some embodiments, user activity data may include information relating to previous resources or systems to which a corresponding user had access. Such information relating to a user's previous activity may serve as a factor in the classification model's determination to provide the user access to additional permissions, for example.

In some embodiments, datasets may correspond to validated users, such as for training the classification model. Validated users may include users that have previously been determined to be reputable or trustworthy enough to provide permission to access a particular resource or permission for a user action. For example, validated users may include users for whom datasets are evaluated for reputability or creditworthiness, such as users for whom loan applications have been granted or determined to be granted. In some cases, datasets (e.g., for training a classification model) may correspond to non-validated users, which may include users for whom datasets are evaluated for reputability or creditworthiness, but for whom a decision has been made not to grant a loan (e.g., not to provide the corresponding user permission to a system or resource). By including information relating to datasets and information for a corresponding user, the system may better evaluate user datasets for whether to grant user permissions on the basis of previous user activity.

FIG. 1B shows an illustrative diagram of flowchart 120 for improving classification model validation using dynamically received input data, in accordance with one or more embodiments. For example, the system may receive raw dataset 124 from set of raw datasets 122 that has been dynamically generated and provide raw dataset 124 to classification model 126 for generation of first output 128. The system may provide first output 128 to a first validation model (e.g., first validation model 130) to generate first validation metric 132. The system may, additionally or alternatively, consider batch data generated from set of raw datasets 122 by converting this data using data transformation 134 into a second data format to generate transformed datasets 136. The system may provide transformed datasets 136 to classification model 138 for generation of outputs 140. Based on these outputs, the system may utilize second validation model 142 to generate second validation metric 144. The system may, on the basis of first validation metric 132 and second validation metric 144, execute model evaluation 146 in order to generate evaluation metric 148. Based on evaluation metric 148, the system enables evaluation of the model validation process for dynamically generated/received datasets (e.g., raw dataset 124) based on higher-quality validation of the classification model using transformed datasets 136. As such, the system may improve the quality of dynamic, real-time model validation on the basis of higher-quality, batch-data model validation.

For example, the system may receive dynamically produced data corresponding to a user, such as raw dataset 124. The system may provide this dataset to classification model 126 for generation or evaluation of the data within the dataset. In some embodiments, classification model 126 (and/or classification model 138) may include a model designed to generate decisions or classifications of data. For example, a classification model may generate labels or categories for input data. As an illustrative example, a classification model may determine whether a user is to be given permission to a system within a cloud storage system depending on the user's credentials, previous activity, or any information within the dataset. Alternatively or additionally, a classification model may include any algorithm for determining whether to disburse a loan to a user based on information provided by the user within the input dataset, including identity information, previous creditworthiness or credit usage information, or other information relating to the user. In some embodiments, the classification model may include machine learning methods, such as artificial neural networks, gradient descent models, k-nearest neighbors algorithms, decision trees, random forest algorithms, or support vector machine models, or combinations thereof. For example, the system may utilize an artificial neural network decision-making model as a classification model. As such, classification models may effectively and accurately categorize data corresponding to users to enable determinations on how to handle user requests.

Classification models (e.g., real-time classification models) may receive real-time and/or unformatted data as input. For example, classification model 126 may receive unformatted or lightly formatted information submitted by a user through, for example, an online form, with few data governance or cleanup operations performed, if any. As an illustrative example, a user may submit a birthday in any one of multiple date formats within the corresponding dataset. The real-time classification model may accept such data without standardization or conversion of the birthday into a particular date format. In some embodiments, the real-time classification model may accept inputs that are missing data or include erroneous data, such as values corresponding to fields or variables that were left blank by the user during submission or were filled out incorrectly by the user. Real-time classification models may be associated with a first validation model, enabling validation or evaluation of the decisions or categorizations determined by the real-time classification model. Because real-time classification models may be more robust in accepting imperfect or poorly formatted data, real-time classification models enable faster model validation, as they may accept data with fewer data transformation steps.

In some embodiments, the real-time classification model may accept model parameters from or may be constructed on the basis of a batch classification model, which may be configured to accept formatted, transformed, or secure data. A batch classification model (e.g., classification model 138) may include a classification model for which input data is transformed, validated, or quality-controlled to some extent. For example, a batch classification model may accept data that is formatted to conform to security or formatting requirements and, as such, may accept data of particular data formats (e.g., a second data format). The system may generate an error message for data submitted to a batch classification model of an invalid data format. For example, the error message may specify discrepancies in the format of an input dataset, including data governance or security steps to be taken for acceptance of the given dataset.

The batch classification model may be associated with a second validation model (e.g., second validation model 142); however, because the batch classification model may require input data that has been formatted, validation of the batch classification model may be slower than validation of the real-time classification model. For example, the batch classification model may only enable validation based on batch input data (e.g., datasets from multiple users) rather than dynamically received input data (e.g., a dataset from a single user). In some embodiments, the batch classification model may serve as a basis for the real-time classification model. For example, the real-time classification model may be configured for faster model validation of a higher-quality batch classification model. As such, results relating to validation of the real-time classification model may be relevant to the batch classification model. Evaluation of the real-time classification model may be used to generate improvements to the batch classification model, such as through provision of more training data or generation of updated model parameters for the batch classification model on the basis of model parameters for the real-time classification model.

In some embodiments, classification models may generate outputs (e.g., first output 128 or outputs 140). The outputs may include categorizations or decisions on the basis of input data, such as evaluation data that characterizes results of an evaluation of a user associated with the input data. For example, a classification model may generate an evaluation of one or more user activities. As an illustrative example, a classification model may include an evaluation of the credentials provided by a user within the dataset, as well as an evaluation of user activity or user reputability. The classification model may generate an output, such as a predicted user permission, that includes whether to provide a user access to a particular system or subsystem of the cloud storage system based on a classification of the input dataset (e.g., based on whether the user may be considered to be trustworthy from provided information and credentials). Alternatively or additionally, an output may include a predicted user permission that includes a determination as to whether to disburse a loan or any other line of credit to a user based on, for example, a credit report or identity of a user. In some embodiments, the system may determine a user evaluation metric, such as a value that quantifies a user's eligibility for permission to access a resource (e.g., access to a system, a loan, or another line of credit). The system may determine a user evaluation status on the basis of the user evaluation metric, such as by comparing the user evaluation metric to a threshold evaluation metric. As an illustrative example, the system may, as output to the classification model, determine whether a user may be eligible for loans and/or may determine a subset of loans for which the user may be eligible. As such, the classification model may improve the reliability and security of the system, while mitigating risks to the system (e.g., cybersecurity or financial risks).

The classification models may be validated using validation models (e.g., first validation model 130 or second validation model 142 shown in FIG. 1B). A validation model may include an algorithm, machine learning model, or other method for evaluating the accuracy, efficiency, or performance of a classification model. For example, a validation model may evaluate the output of a classification model in relation to the input of the classification model to determine whether the output is an accurate reflection of the input of the classification model. For example, the validation model may determine whether a predicted user permission from the validation model corresponds to a determined user permission, where the determined user permission indicates a ground-truth determination or evaluation of the user. For example, the validation model may, on the basis of input datasets, generate a corresponding predicted user permission and compare this predicted user permission with a determined user permission (e.g., as determined by an external system or by the batch classification model). The system may determine validation metrics, attributes, or information accordingly. For example, the validation model may generate validation metrics (e.g., quantifications of model accuracy, such as first validation metric 132 or second validation metric 144), based on input data, the corresponding output, and additional ground-truth data. The validation model may receive a validation dataset corresponding to various datasets of various users, where each user is associated with a corresponding validation indicator. The validation indicators may include indications of a determined user permission (e.g., whether the corresponding user has been determined to be eligible for access to a system or provision of a loan). In some embodiments, the validation metric may include a percentage match, where the percentage match indicates a fraction of outputs that are deemed accurate or correct. Alternatively or additionally, the validation metric may be generated by a machine learning model (e.g., an artificial neural network) based on an evaluation of the input data and the corresponding output from the classification model.

The validation model may include or make use of a real-time classification model. For example, first validation model 130 may be configured to utilize a real-time classification model (e.g., classification model 126) in order to accept unformatted or lightly formatted input data for validation. In contrast, a validation model (e.g., second validation model 142) may be configured to utilize or include a batch classification model (e.g., classification model 138), where input data may be formatted or validated (e.g., for security or data governance reasons). As such, the second validation model may include higher-quality validations than the first validation model. However, because first validation model 130 may be configured to accept dynamically received input data, the first validation model may be configured to validate and, as such, generate improvements to the classification model more efficiently. The system may improve the quality of real-time model validations (e.g., on the basis of the real-time classification model) based on information received from the batch model validations. As an illustrative example, the system may generate updated model parameters (e.g., model weights for a corresponding artificial intelligence model) for the first validation model (e.g., including updated model parameters for the real-time classification model) based on its performance as compared to the second validation model for the higher-quality batch classification model. By doing so, the system may improve the quality of real-time model validation, thereby improving the efficiency of model improvements to the classification model.

In some embodiments, the first validation model for the dynamically received data may utilize prior validation data to generate model evaluations. For example, while the second validation model may receive information associated with multiple datasets together (e.g., batch data), the first validation model may receive information or inputs that are unformatted and/or dynamically received. As such, the first validation model may consider validation results for previously validated model inputs and outputs in order to determine the overall classification model accuracy. For example, the first validation model may consider a moving average of previous validation results to generate the validation metric.

In some embodiments, the system may evaluate the model (e.g., during model evaluation 146) to generate an evaluation metric (e.g., evaluation metric 148), where the evaluation metric indicates performance of the first validation model in relation to the second validation model. For example, the system may compare the validation metric of the first validation model with a second validation metric of the second validation model to determine an evaluation metric and determine whether the first validation model could benefit from updating or further training. As an illustrative example, the system may determine that the first validation metric is lower than the second validation metric by a first difference value (e.g., the evaluation metric). In situations where the first difference value is greater than a threshold difference, the system may determine to train the first validation model, such as by altering the algorithm or model weights corresponding to the first validation model, or by updating model parameters associated with an associated real-time classification model (e.g., by further training the real-time classification model on the basis of training data). By doing so, the system may improve real-time validation of dynamically received input data, even if such input data is less reliable or robust than transformed or validated input data.

FIG. 1C shows an illustrative diagram of data structure 160 for data transformation rules for generating datasets of a second data format from datasets of a first data format, in accordance with one or more embodiments. For example, data transformation rules 162 include information relating to conversion of values corresponding to variables 164 from a first data format to a second data format. For example, data transformation rules 162 may specify values of an original format 166, as well as actions 168 to be taken with respect to these values to generate values of a transformed format 170. The variables of this transformed format, as well as the corresponding variables, may define or embody the second data format. By including data transformation rules 162 for new data formats, the system enables processing of raw, dynamically produced input data into data formats that are acceptable to a classification model and corresponding validation model, such as for satisfaction of data governance, security, or formatting requirements.

As an illustrative example, the system may define transformation criteria utilizing data structure 160 and/or data transformation rules 162. Transformation criteria may include criteria for conversion of data of a first data format to data of a second data format. For example, transformation criteria may specify rules or protocols for handling received raw input data. The transformation criteria may specify that values corresponding to certain variables may need to be transformed, split, acted upon, or otherwise modified to generate data of the second data format.

The system may determine to look up or supplement information within the input dataset in order to generate a second data format. For example, the system may look up a username provided within a dataset in a user database to generate a full name corresponding to the user. In some embodiments, the system may generalize or transform a value corresponding to a variable according to pre-determined rules. For example, if an input dataset specifies a region of registration (e.g., an address or region associated with the user), the system may transform or generalize this value to include a description of a larger region. The system may convert a value corresponding to a state (e.g., “Colorado-US” as shown in FIG. 1C) to a value corresponding to a country (e.g., “United States” as shown in FIG. 1C). In some embodiments, the system may split a variable of an original format into multiple variables (and perform the same operation for the corresponding value). For example, the system may split a birthday into its corresponding month, day, and year, and store these as another set of variables in the second data format. In some embodiments, the system may update or verify details within the dataset. For example, the system may update a reputability metric (e.g., a credit score) for a user based on current information to generate an updated reputability metric, as shown in FIG. 1C. In some embodiments, the system may transform, convert, or translate information from the first data format to the second data format. For example, a value associated with an account status may correspond to “Active” in a first data format. The system may convert all entries with the value “Active” to a “1” in the second data format. By converting, modifying, or verifying values through the transformation criteria, the system may improve the quality of input data to the classification model and corresponding validation model, thereby improving model performance and accuracy. In some embodiments, the system may also perform transformations, such as encryption or other security measures, in order to improve the security of the input information (e.g., to comply with data governance requirements).

In some embodiments, a data format may be associated with a specification (e.g., of rules, protocols, or requirements). For example, a specification may include format requirements or security requirements for the second data format. As an illustrative example, format requirements may include indications of acceptable data structures or formats for the data. For example, a format requirement may specify a preferred or required format for dates (e.g., an international standard), or specification of array sizes, file sizes, or other data storage-related parameters. In some embodiments, format requirements include requirements for how to store particular values. Alternatively or additionally, format requirements may specify the set of variables to be included within the dataset and/or the data structures or types in which to store the corresponding values.

In some embodiments, the specification may include security requirements for data within a dataset. For example, security requirements may include encryption protocols, specification of secure data formats or network security protocols, or cybersecurity-related requirements. Security requirements, for example, may specify that values corresponding to variables may be stored using public-private key encryption or digital signatures. For example, by specifying security requirements for the storage of data, the system enables handling of secure data (e.g., user identity data, financial data, or other personal identifiable information (PII)). Such security requirements may be associated with received data governance rules. In some embodiments, the system generates a warning message if a dataset (e.g., a dataset provided to a classification model) does not correspond to any requested or required format requirements or security requirements. For example, the system may detect whether a dataset provided to a classification model includes erroneous or missing values and generate a warning in response to this detection. By doing so, the system improves the security and quality of the classification model by improving the consistency and security of received data.

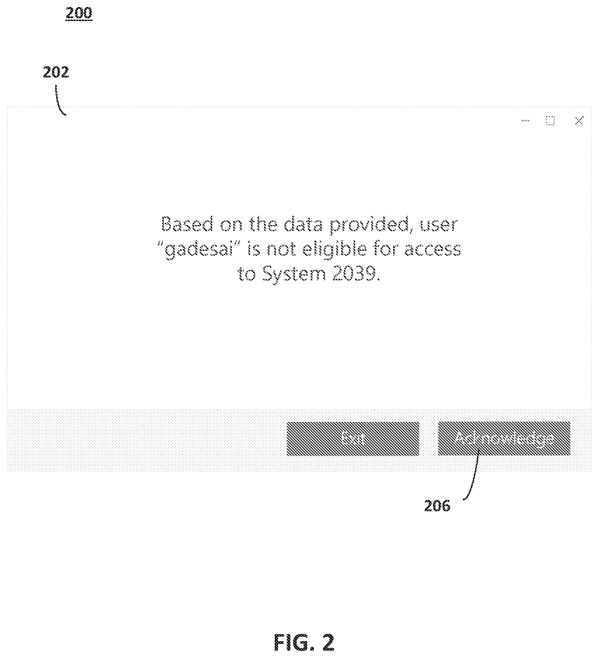

FIG. 2 shows an illustrative diagram of a display of a result of the classification model based on input user data, in accordance with one or more embodiments. For example, display 200 may illustrate dialog box 202, with an indication of a user permission (or lack thereof). For example, the system may generate dialog box 202 to include one or more user controls, such as an acknowledgment button 206. Classification models associated with the system may evaluate input datasets corresponding to users in order to determine whether to provide users with permission to access system resources or financial instruments, such as lines of credit. In some embodiments, the system may display a set of systems or options (e.g., loan options) for which the user is qualified and enable the user to select one or more of these options utilizing a control (e.g., a drop-down menu, check boxes, or radio buttons). As such, the system enables evaluation of user datasets in order to determine user permissions and disburse any resources, loans, or lines of credit according to these evaluations.

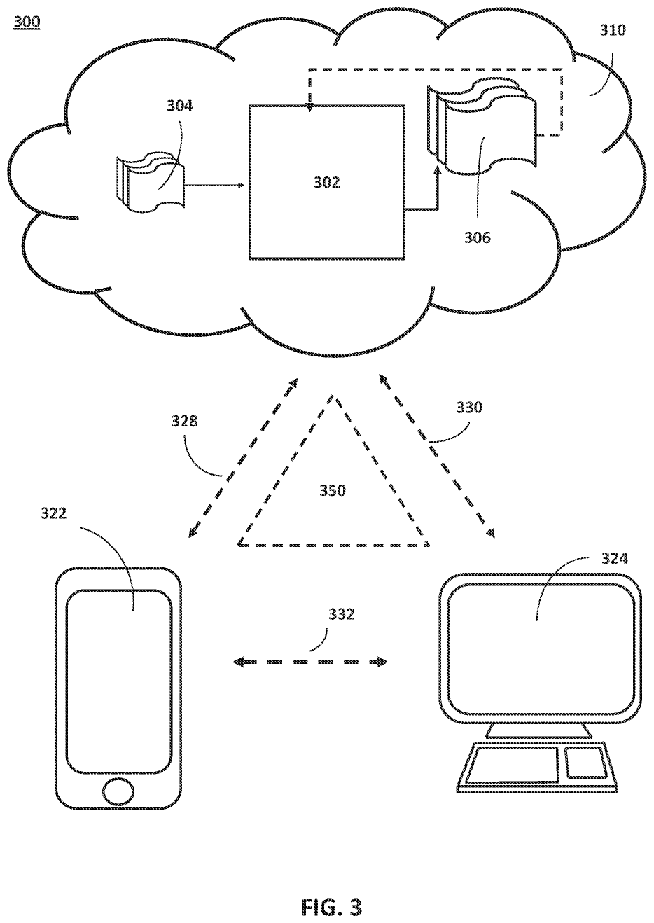

FIG. 3 shows illustrative components for a system used to perform model validation based on dynamically received input data, in accordance with one or more embodiments. For example, FIG. 3 may show illustrative components for improving classification models that evaluate user data to determine whether the user is eligible for requested resources, such as lines of credit or loans. As shown in FIG. 3, system 300 may include mobile device 322 and user terminal 324. While shown as a smartphone and a personal computer, respectively, in FIG. 3, it should be noted that mobile device 322 and user terminal 324 may be any computing device, including, but not limited to, a laptop computer, a tablet computer, a hand-held computer, and other computer equipment (e.g., a server), including “smart,” wireless, wearable, and/or mobile devices. FIG. 3 also includes cloud components 310. Cloud components 310 may alternatively be any computing device as described above, and may include any type of mobile terminal, fixed terminal, or other device. For example, cloud components 310 may be implemented as a cloud computing system, and may feature one or more component devices. It should also be noted that system 300 is not limited to three devices. Users may, for instance, utilize one or more devices to interact with one another, one or more servers, or other components of system 300. It should be noted that, while one or more operations are described herein as being performed by particular components of system 300, these operations may, in some embodiments, be performed by other components of system 300. As an example, while one or more operations are described herein as being performed by components of mobile device 322, these operations may, in some embodiments, be performed by components of cloud components 310. In some embodiments, the various computers and systems described herein may include one or more computing devices that are programmed to perform the described functions. Additionally, or alternatively, multiple users may interact with system 300 and/or one or more components of system 300. For example, in one embodiment, a first user and a second user may interact with system 300 using two different components.

With respect to the components of mobile device 322, user terminal 324, and cloud components 310, each of these devices may receive content and data via input/output (I/O) paths. Each of these devices may also include processors and/or control circuitry to send and receive commands, requests, and other suitable data using the I/O paths. The control circuitry may comprise any suitable processing, storage, and/or I/O circuitry. Each of these devices may also include a user input interface and/or user output interface (e.g., a display) for use in receiving and displaying data. For example, as shown in FIG. 3, both mobile device 322 and user terminal 324 include a display upon which to display data (e.g., conversational responses, queries, and/or notifications).

Additionally, as mobile device 322 and user terminal 324 are shown as a touchscreen smartphone and a personal computer, respectively, these displays also act as user input interfaces. It should be noted that in some embodiments, the devices may have neither user input interfaces nor displays, and may instead receive and display content using another device (e.g., a dedicated display device such as a computer screen and/or a dedicated input device such as a remote control, mouse, voice input, etc.). Additionally, the devices in system 300 may run an application (or another suitable program). The application may cause the processors and/or control circuitry to perform operations related to generating dynamic conversational replies, queries, and/or notifications.

Each of these devices may also include electronic storages. The electronic storages may include non-transitory storage media that electronically stores information. The electronic storage media of the electronic storages may include one or both of (i) system storage that is provided integrally (e.g., substantially non-removable) with servers or client devices, or (ii) removable storage that is removably connectable to the servers or client devices via, for example, a port (e.g., a USB port, a firewire port, etc.) or a drive (e.g., a disk drive, etc.). The electronic storages may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. The electronic storages may include one or more virtual storage resources (e.g., cloud storage, a virtual private network, and/or other virtual storage resources). The electronic storages may store software algorithms, information determined by the processors, information obtained from servers, information obtained from client devices, or other information that enables the functionality as described herein.

FIG. 3 also includes communication paths 328, 330, and 332. Communication paths 328, 330, and 332 may include the Internet, a mobile phone network, a mobile voice or data network (e.g., a 5G or LTE network), a cable network, a public switched telephone network, or other types of communications networks or combinations of communications networks. Communication paths 328, 330, and 332 may separately or together include one or more communication paths, such as a satellite path, a fiber-optic path, a cable path, a path that supports Internet communications (e.g., IPTV), free-space connections (e.g., for broadcast or other wireless signals), or any other suitable wired or wireless communication path or combination of such paths. The computing devices may include additional communication paths linking a plurality of hardware, software, and/or firmware components operating together. For example, the computing devices may be implemented by a cloud of computing platforms operating together as the computing devices.

Cloud components 310 may include classification models (e.g., real-time or batch models), validation models (e.g., the first or second validation models), data governance structures, or databases, such as databases associated with user data or training data for the classification models or validation models. Cloud components 310 may access data structures, such as raw datasets of a first data format, transformed datasets of a second data format, training data for classification models, training data for validation models, transformation criteria, and/or specifications for data formats (including format requirements or security requirements). For example, cloud components 310 may access public or private keys, hashes, or other tokens for generation of encrypted data (e.g., for public-private encryption or digital signatures).

Cloud components 310 may include model 302, which may be a machine learning model, an artificial intelligence model, etc. (which may be referred to collectively as “models” herein). Model 302 may take inputs 304 and provide outputs 306. The inputs may include multiple datasets, such as a training dataset and a test dataset. Each of the plurality of datasets (e.g., inputs 304) may include data subsets related to user data, predicted forecasts and/or errors, and/or actual forecasts and/or errors. In some embodiments, outputs 306 may be fed back to model 302 as input to train model 302 (e.g., alone or in conjunction with user indications of the accuracy of outputs 306, labels associated with the inputs, or other reference feedback information). For example, the system may receive a first labeled feature input, wherein the first labeled feature input is labeled with a known prediction for the first labeled feature input. The system may then train the first machine learning model to classify the first labeled feature input with the known prediction (e.g., whether a user is eligible for a particular system permission, such as a line of credit or a loan). In some embodiments, the system may train a machine learning model to generate a validation metric for a classification model quantifying model performance.

In a variety of embodiments, model 302 may update its configurations (e.g., weights, biases, or other parameters) based on the assessment of its prediction (e.g., outputs 306) and reference feedback information (e.g., user indication of accuracy, reference labels, or other information). In a variety of embodiments, where model 302 is a neural network, connection weights may be adjusted to reconcile differences between the neural network's prediction and reference feedback. In a further use case, one or more neurons (or nodes) of the neural network may require that their respective errors be sent backward through the neural network to facilitate the update process (e.g., backpropagation of error). Updates to the connection weights may, for example, be reflective of the magnitude of error propagated backward after a forward pass has been completed. In this way, for example, model 302 may be trained to generate better predictions.

In some embodiments, model 302 may include an artificial neural network. In such embodiments, model 302 may include an input layer and one or more hidden layers. Each neural unit of model 302 may be connected with many other neural units of model 302. Such connections can be enforcing or inhibitory in their effect on the activation state of connected neural units. In some embodiments, each individual neural unit may have a summation function that combines the values of all of its inputs. In some embodiments, each connection (or the neural unit itself) may have a threshold function such that the signal must surpass it before it propagates to other neural units. Model 302 may be self-learning and trained, rather than explicitly programmed, and can perform significantly better in certain areas of problem solving, as compared to traditional computer programs. During training, an output layer of model 302 may correspond to a classification of model 302, and an input known to correspond to that classification may be input into an input layer of model 302 during training. During testing, an input without a known classification may be input into the input layer, and a determined classification may be output.

In some embodiments, model 302 may include multiple layers (e.g., where a signal path traverses from front layers to back layers). In some embodiments, backpropagation techniques may be utilized by model 302 where forward stimulation is used to reset weights on the “front” neural units. In some embodiments, stimulation and inhibition for model 302 may be more free-flowing, with connections interacting in a more chaotic and complex fashion. During testing, an output layer of model 302 may indicate whether or not a given input corresponds to a classification of model 302 (e.g., whether or not a user is eligible for access to a particular resource, such as a line of credit or a loan).

In some embodiments, the model (e.g., model 302) may automatically perform actions based on outputs 306. In some embodiments, the model (e.g., model 302) may not perform any actions. The output of the model (e.g., model 302) may be used to evaluate outputs of models to generate validation metrics. In some embodiments, the output of the model may be used to determine whether to provide access to resources, such as lines of credit or loans, based on a user's determined creditworthiness.

System 300 also includes application programming interface (API) layer 350. API layer 350 may allow the system to generate summaries across different devices. In some embodiments, API layer 350 may be implemented on mobile device 322 or user terminal 324. Alternatively or additionally, API layer 350 may reside on one or more of cloud components 310. API layer 350 (which may be a REST or Web services API layer) may provide a decoupled interface to data and/or functionality of one or more applications. API layer 350 may provide a common, language-agnostic way of interacting with an application. Web services APIs offer a well-defined contract, called WSDL, that describes the services in terms of their operations and the data types used to exchange information. REST APIs do not typically have this contract; instead, they are documented with client libraries for most common languages, including Ruby, Java, PHP, and JavaScript. SOAP Web services have traditionally been adopted in the enterprise for publishing internal services, as well as for exchanging information with partners in B2B transactions.

API layer 350 may use various architectural arrangements. For example, system 300 may be partially based on API layer 350, such that there is strong adoption of SOAP and RESTful Web services, using resources like Service Repository and Developer Portal, but with low governance, standardization, and separation of concerns. Alternatively, system 300 may be fully based on API layer 350, such that separation of concerns between layers like API layer 350, services, and applications are in place.

In some embodiments, the system architecture may use a microservice approach. Such systems may use two types of layers: front-end layer and back-end layer, where microservices reside. In this kind of architecture, the role of API layer 350 may provide integration between front-end and back-end layers. In such cases, API layer 350 may use RESTful APIs (exposition to front-end or even communication between microservices). API layer 350 may use AMQP (e.g., Kafka, RabbitMQ, etc.). API layer 350 may use incipient usage of new communications protocols such as gRPC, Thrift, etc.

In some embodiments, the system architecture may use an open API approach. In such cases, API layer 350 may use commercial or open source API platforms and their modules. API layer 350 may use a developer portal. API layer 350 may use strong security constraints applying WAF and DDOS protection, and API layer 350 may use RESTful APIs as standard for external integration.

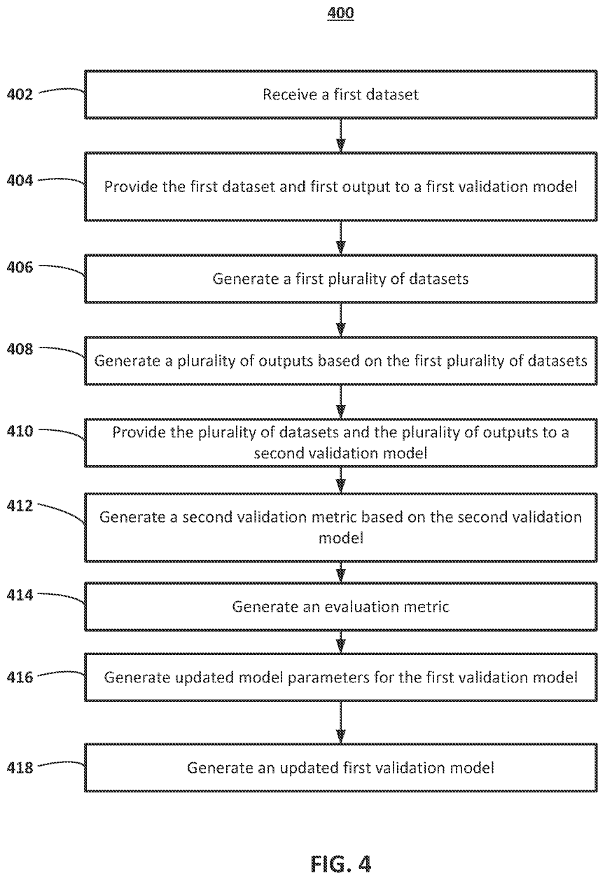

FIG. 4 shows a flowchart of the steps involved in improving model validation based on dynamically received input data based on model performance from batch-produced inputs, in accordance with one or more embodiments. For example, the system may use process 400 (e.g., as implemented on one or more system components described above) in order to improve classification models for evaluating users for eligibility for lines of credit (e.g., loans) based on input data associated with the users.

At step 402, process 400 (e.g., using one or more components described above) enables the system to receive a first dataset. For example, the system may receive a first dataset, where the first dataset includes information in a first data format corresponding to a first user. The first dataset may include information relating to a user, such as the user's identifier, birthday, address, or activity history. The dataset may be in a raw or lightly processed format, such as information submitted by the user through an online form or mobile application. The system may leverage such information relating to a user to generate an evaluation of the user using a classification model, such as for determining eligibility or permission to acquire resources, such as lines of credit. Additionally or alternatively, the system may utilize the dataset to validate or train the classification model. As such, by receiving such information relating to a user, the system may improve determinations of user permissions or eligibility, thereby improving system security and robustness.

At step 404, process 400 (e.g., using one or more components described above) enables the system to provide the first dataset and a first output to a first validation model. For example, the system may provide the first dataset to a classification model in order to generate the first output. The first output may include first evaluation data associated with the first user. The system may provide this first output, as well as the first dataset, to a first validation model to generate a first validation metric pertaining to the classification model. As an illustrative example, the system may generate a user evaluation as output, such as a determination of the eligibility of a user for access to a requested line of credit. This evaluation may be based on the user dataset, comprising information pertaining to the user. Based on this output, the system may validate the performance of the classification model by providing the output to a validation model. For example, the validation model may receive or include information relating to a determined evaluation status of the user (e.g., as determined by an authoritative data source or a more accurate classification model). As such, the system may generate a validation metric that quantifies the classification model's performance. By generating such a validation metric, the system enables dynamic evaluation of the accuracy and performance of the classification model based on raw datasets, thereby enabling efficient model validation and subsequent improvements to the model's accuracy.

In some embodiments, the system may evaluate user activity associated with the user in order to determine the output (e.g., a predicted user permission). For example, the system may generate the first validation metric for the classification model by determining first user activity data from the first dataset, wherein the first user activity data includes information characterizing activities by the first user. The system may provide the first user activity data to the classification model, wherein the classification model is an artificial neural network-based decision-making model. Based on providing the first user activity data to the classification model, the system may generate the first output, wherein the first output indicates a first predicted user permission. The system may generate the first validation metric based on the first predicted user permission. As an illustrative example, the system may evaluate previous activity associated with a user, such as previous transactions, lines of credit, or credit card balances maintained by the user, in order to determine a permission for the user to access further resources (e.g., lines of credit or other financial instruments). For example, the system may provide such activities to an artificial neural network for determination of a prediction of whether a user is eligible for permission to access a loan. The system may generate the validation metric on the basis of this output (e.g., the predicted user permission). For example, the system may provide this permission to the first validation model to determine the classification model's performance with respect to this user dataset, and evaluate the model accordingly. By doing so, the system enables dynamic evaluation of classification models on the basis of the accuracy of the classification of a user's predicted permission to access a resource, thereby enabling efficient model validation and subsequent model training.

In some embodiments, the system may generate the first validation metric based on validation indicators provided to the system. For example, the system may obtain a first validation indicator for the first user, wherein the first validation indicator indicates a first determined user permission for the first user. The system may provide the first validation indicator, the first output, and the first user activity data to the first validation model to generate the first validation metric. For example, the system may evaluate the accuracy of the classification model by providing an expected output (e.g., a previously determined user permission) with the actual output from the model (e.g., a predicted user permission from the classification model). The expected output may be an output generated by a more accurate model, such as the batch classification model. Alternatively or additionally, the expected output may be pre-determined manually. By providing such ground-truth information relating to a corresponding user's actual permission status, the system enables validation of the classification model for dynamically received input data and subsequent generation of a validation metric.

In some embodiments, the system may generate the validation metric based on matching determined user permissions and predicted user permissions. For example, the system may determine a match between the first determined user permission and the first predicted user permission. The system may obtain prior validation data for the classification model, wherein the prior validation data includes indications of matches between determined user permissions and predicted user permissions for a set of datasets, wherein the set of datasets includes a pre-determined number of datasets previously provided to the classification model. Based on the match and the prior validation data, the system may update a moving-average accuracy metric for the classification model. The system may determine the first validation metric based on the moving-average accuracy metric for the classification model. For example, the system may determine whether the determined user permission indeed corresponds to the predicted user permission—that is, the system may evaluate whether a user who is indicated, by the determination, as being eligible for a particular loan is indeed eligible according to more accurate determination methods. Based on this evaluation, the system may update a moving-average accuracy metric relating to the classification model based on the performance of the model in accurately capturing previous users' permissions. For example, the system may store indications of previous outputs (e.g., previous predicted user permissions) of the classification model, and evaluations of whether these previous outputs matched the corresponding ground-truth indications (e.g., the corresponding determined user permissions) for a specified number of previous outputs. The system may, accordingly, calculate a moving average indicating a percentage of these matches for a pre-determined number of previous outputs, thereby enabling model validation for dynamically received input data.

In some embodiments, the system may determine the validation metric based on providing the input data to a real-time classification model (e.g., rather than a batch classification model). For example, the system may determine a real-time classification model, wherein the real-time classification model is configured to accept datasets of the first data format without modification. The system may determine that the first dataset includes missing values or erroneous values. The system may provide the first dataset to the real-time classification model. The system may generate the first output based on providing the first dataset to the real-time classification model. For example, the system may utilize a real-time classification model capable of accepting raw, unprocessed (e.g., lightly processed) input data in order to generate the first output and subsequent first validation metric. As an illustrative example, the system may utilize a variation or modification of a batch classification model, where this real-time classification model is able to handle dynamically received input data that has not been processed for formatting or security requirements. As an illustrative example, the real-time classification model may generate outputs for datasets that are missing values or include erroneous values, such as datasets that are missing birthdays or credit scores. By generating the output based on this real-time classification model, the system enables more efficient model validation dynamically, without relying on batch-produced or batch-processed data.

In some embodiments, the first validation model may include a machine learning model capable of evaluating or generating user evaluation metrics based on user data. For example, the system may provide the first dataset to a machine learning model, wherein the machine learning model is a model configured to generate user evaluation metrics based on user data. The system may generate a user evaluation status for the first user based on providing the first dataset and the first output to the machine learning model. The system may provide the first dataset and the user evaluation status to the first validation model. As an illustrative example, the system may generate a user evaluation status for a user by generating a user evaluation metric as output from the machine learning model and comparing this metric with a threshold evaluation metric. A user evaluation status may include an indication as to whether a user is eligible for a loan or line of credit based on data associated with the user (e.g., the first dataset). By leveraging a machine learning model for generation of an evaluation of the user, the system enables accurate, quantitative determinations of a user's trustworthiness or creditworthiness, thereby improving the quality of the classification model.

At step 406, process 400 (e.g., using one or more components described above) enables the system to generate a first plurality of datasets of a second data format. For example, the system may generate a first plurality of datasets, wherein the first plurality of datasets includes representations of the first dataset in a second data format and a second plurality of datasets corresponding to a plurality of users. As an illustrative example, the system may utilize transformation criteria on a set of unprocessed or lightly processed datasets in order to determine a plurality of datasets in a second data format (e.g., as shown in relation to FIG. 1C). The system may impose security or formatting requirements, such as encryption or modifications to formats of variables, in order to secure and improve the quality of the input data. By doing so, the system enables more accurate, batch-produced classifications of data and subsequent validation of the associated classification model.

In some embodiments, the system may generate the first plurality of datasets by modifying a set of values corresponding to a set of variables within each dataset. For example, the system may determine a set of values for the first dataset, wherein the set of values includes values associated with a set of variables within the first dataset. The system may modify the set of values to generate a modified set of values associated with a modified set of variables. The system may generate a first representation of the first dataset in the second data format based on the modified set of values. In some embodiments, the system may execute these operations for any or all other datasets within the second plurality of datasets. For example, the system may determine values associated with variables 164, as shown in FIG. 1C, and carry out operations (e.g., look up, generalize, split, update, or transform) on the values according to data transformation rules 162. By doing so, the system may standardize input data, thereby improving the consistency and quality of data for further classification and model validation.

In some embodiments, the system may split data or values within the datasets in order to generate datasets of the second data format. For example, the system may determine a first value corresponding to a first variable in the first dataset. The system may generate a second value and a third value, wherein the first value comprises the second value and the third value, wherein the second value is associated with a second variable, and wherein the third value is associated with a third variable. The system may generate the modified set of values to include the second value and the third value. The system may generate the modified set of variables to include the second variable and the third variable. As an illustrative example, the system may detect a birthday within a single variable in the first dataset, as shown in FIG. 1C. The system may split the birthday into its constituent month, day, and year, thereby generating three new variables and corresponding values. The system may store these values within a modified dataset within the first plurality of datasets, where this modified dataset is of the second data format. By doing so, the system may improve the quality of input data through standardization of data pertaining to users for further processing and evaluation (e.g., by avoiding formats that vary by region or by user).

In some embodiments, the system may validate values within the dataset and modify such values accordingly. For example, the system may generate a plurality of validation statuses for the set of values, wherein each validation status for the set of values indicates a validity of a corresponding value of the set of values for a corresponding variable of the set of variables. The system may generate a set of validated values corresponding to a set of validated variables, wherein each validated value of the set of validated values indicates a corresponding valid value of the set of values. The system may generate the modified set of values to include the set of validated values. As an illustrative example, the system may determine that a reputability metric (e.g., a credit score) within a dataset is wrong or outdated, and thereby generate a validation status indicating that the metric included within the dataset is invalid. In response to this determination, the system may generate a validated value (e.g., by looking up the user's credit score within a database of credit scores) in order to modify this value. By doing so, the system may improve the quality of input data, thereby improving the quality of subsequent user evaluations for loan applications and associated model validation.

In some embodiments, the system may generate the data of the second data format using a specification of the second data format. For example, the system may obtain a specification for the second data format, wherein the specification indicates format requirements for the second data format and security requirements for the second data format. The system may generate a first representation of the first dataset in the second data format to include data satisfying the format requirements and the security requirements. As an illustrative example, the system may obtain security or encryption requirements relating to the data, such as an encryption standard and associated keys (e.g., public or private) with which to encrypt the datasets. In response to obtaining these security requirements, the system may transform data within the datasets accordingly in order to generate the data of the second data format. Additionally or alternatively, the specification may include formatting requirements, such as a specification of data structures or value formats for datasets. By obtaining and applying such requirements to the dataset, the system improves the security, consistency, and, therefore, quality of data for further evaluation of the users' datasets and classification model performance.

At step 408, process 400 (e.g., using one or more components described above) enables the system to generate a plurality of outputs based on the first plurality of datasets. For example, the system may generate, from the classification model, a plurality of outputs based on the first plurality of datasets, wherein each output of the plurality of outputs includes corresponding data of a corresponding user of the plurality of users. As an illustrative example, the system may generate evaluations of whether each user of the plurality of users is eligible for a requested resource (e.g., a loan or a line of credit), based on providing the data of the second data format to the classification model. These evaluations may correspond to predicted user permissions, such as predicted results of loan application decisions corresponding to users. By generating such information, the system enables evaluation of generated user evaluation data, as well as evaluation of the classification model's performance on the basis of these predicted user permissions.

In some embodiments, the system may utilize a batch classification model (e.g., as opposed to a real-time classification model) for generation of these outputs. For example, the system may determine a batch classification model, wherein the batch classification model is configured to accept datasets of the second data format. The system may detect that a second dataset of the second plurality of datasets includes data inconsistent with the second data format. The system may generate, for display in a user interface of a user device, an error message, wherein the error message indicates that the second dataset is of an invalid data format for the batch classification model. As an illustrative example, the system may generate the outputs using a classification model that is configured to accept only data of the second data format (e.g., data subject to data governance restrictions). As such, the outputs may be of higher quality or more accurate than outputs of a real-time classification model; however, such data may be evaluated or determined only in bulk (e.g., for batch data).

At step 410, process 400 (e.g., using one or more components described above) enables the system to provide the plurality of datasets and the plurality of outputs to a second validation model. For example, the system may provide the first plurality of datasets and the plurality of outputs to a second validation model. At step 412, process 400 (e.g., using one or more components described above) enables the system to generate a second validation metric based on the second validation model. As an illustrative example, the system may evaluate the quality of the outputs (e.g., user evaluations) generated by the batch classification model from the inputs of the second data format. By doing so, the system enables evaluation of the classification model using higher-quality data and outputs, thereby enabling improved model validation over the real-time classification model and the first validation model.

In some embodiments, the system may generate the validation metric by generating a percentage match that indicates an overall accuracy of the classification model with respect to the first plurality of datasets. For example, the system may receive a validation dataset, wherein the validation dataset includes a plurality of validation indicators, wherein each validation indicator of the plurality of validation indicators indicates a corresponding determined user permission for a corresponding dataset of the first plurality of datasets. The system may compare each validation indicator of the plurality of validation indicators with a corresponding output of the plurality of outputs. Based on comparing each validation indicator of the plurality of validation indicators with the corresponding output of the plurality of outputs, the system may generate a percentage match, wherein the plurality of outputs includes a plurality of predicted user permissions corresponding to the plurality of users, and wherein the percentage match indicates a fraction of validation indicators of the plurality of validation indicators that are consistent with corresponding outputs of the plurality of outputs. The system may generate the second validation metric to include the percentage match. As an illustrative example, the system may determine which of the outputs of the plurality of outputs is accurate (e.g., by comparing the predicted user permissions, such as predicted loan approvals, with a set of determined user permissions, corresponding to the validation indicators). As such, the system may leverage the batch nature of the first plurality of datasets in order to evaluate the classification model, thereby providing an accurate metric for classification model validation.

At step 414, process 400 (e.g., using one or more components described above) enables the system to generate an evaluation metric. For example, the system may generate an evaluation metric of the first validation model with respect to the second validation model based on a comparison between the first validation metric and the second validation metric. As an illustrative example, the system may determine whether the first validation metric is significantly different compared to the second validation metric (e.g., thereby indicating that the first validation model is not accurately capturing the performance of the classification model). Based on determining that this difference is larger than a threshold value, the system may determine to update model parameters or the algorithm associated with the first validation model. Because the first validation model and the first validation metric may be associated with dynamically received, lightly processed input data and/or a real-time classification model, the first validation metric may be less reliable than the second validation metric. As such, by comparing the two values, the system enables improvements to the dynamic model validation with the first validation model on the basis of identifying discrepancies with the more accurate second validation model. By doing so, the system enables faster, more efficient real-time validation of the classification models based on real-time generated, lightly processed data.

At step 416, process 400 (e.g., using one or more components described above) enables the system to generate updated model parameters for the first validation model and/or the real-time classification model. For example, the system may generate a plurality of updated model parameters for the first validation model. At step 418, process 400 (e.g., using one or more components described above) enables the system to generate an updated first validation model. For example, the system may generate an updated first validation model based on the plurality of updated model parameters. As an illustrative example, the system may update the first validation model using values of the second validation model upon determining that the first validation model is struggling to accurately evaluate the inputs and outputs for classification model performance. Additionally or alternatively, the system may determine to generate updated model parameters for the real-time classification model. For example, the system may update the real-time classification model based on model parameters associated with the batch classification model. In some embodiments, the system may update parameters for the real-time classification model by training the real-time classification model using outputs of the batch classification model and the corresponding inputs, thereby leveraging the higher-quality inputs and data of the batch classification model. As such, the system enables improvements to model validation for real-time validation models and/or dynamically received inputs.

In some embodiments, the system may receive further data corresponding to previously validated users for training of the classification model. For example, the system may receive a third plurality of datasets corresponding to a plurality of validated users (e.g., users for whom loan applications have been previously approved or denied). The system may receive a validation dataset, wherein the validation dataset includes a plurality of validation indicators, and wherein each validation indicator of the plurality of validation indicators indicates a corresponding determined user permission for a corresponding dataset of the third plurality of datasets. The system may provide the third plurality of datasets and the validation dataset to the classification model. Based on providing the third plurality of datasets and the validation dataset to the classification model, the system may train the classification model to predict user permissions for users as output. For example, the system may receive inputs associated with users for whom user permissions have already been determined (e.g., by third parties, by external credit agencies, or by a more accurate classification model). As such, the system enables training of the classification model based on user permissions associated with previously validated users.

In some embodiments, the system may train the classification model based on the updated validation model. For example, the system may retrieve a second dataset corresponding to a second user. The system may provide the second dataset to the classification model to generate a second output. The system may provide the second dataset and the second output to the updated first validation model to generate a third validation metric. The system may provide the third validation metric and the second dataset to the classification model. Based on providing the third validation metric and the second dataset to the classification model, the system may train the classification model to generate evaluation data for users. As an illustrative example, the system may utilize information relating to model validation results (e.g., through the first validation model) in order to update the classification model to generate more accurate results. By doing so, the system enables leveraging of the first validation model, which may be provisioned to provide efficient model validation based on dynamically received and/or lightly processed/unprocessed data, for improvements to the classification model. As such, the disclosed systems and methods enable efficient improvements to user evaluation for the provision of loans, for example.

In some embodiments, the system may utilize the classification model to determine whether a user is permitted access to a particular resource (e.g., a loan or a line of credit). For example, the system may receive a third dataset from a user device, wherein the third dataset is associated with a third user. The system may provide the third dataset to the classification model to generate third output. The system may generate a user permission for the third user based on the third output. The system may generate the user permission for display on a user interface associated with the user device. As an illustrative example, the system may leverage the validated classification model in order to evaluate users for whether they may be eligible for loans, for example. Because the classification model may be validated and improved efficiently due to the first validation model, the system enables faster and more accurate classification of users.

It is contemplated that the steps or descriptions of FIG. 4 may be used with any other embodiment of this disclosure. In addition, the steps and descriptions described in relation to FIG. 4 may be done in alternative orders or in parallel to further the purposes of this disclosure. For example, each of these steps may be performed in any order, in parallel, or simultaneously to reduce lag or increase the speed of the system or method. Furthermore, it should be noted that any of the components, devices, or equipment discussed in relation to the figures above could be used to perform one or more of the steps in FIG. 4.

The above-described embodiments of the present disclosure are presented for purposes of illustration and not of limitation, and the present disclosure is limited only by the claims which follow. Furthermore, it should be noted that the features and limitations described in any one embodiment may be applied to any embodiment herein, and flowcharts or examples relating to one embodiment may be combined with any other embodiment in a suitable manner, done in different orders, or done in parallel. In addition, the systems and methods described herein may be performed in real time. It should also be noted that the systems and/or methods described above may be applied to, or used in accordance with, other systems and/or methods.

The present techniques will be better understood with reference to the following enumerated embodiments:
1. A method comprising: receiving a first dataset, wherein the first dataset comprises information in a first data format corresponding to a first user; based on providing the first dataset and first output to a first validation model, generating a first validation metric for a classification model, wherein the first output is generated based on providing the first dataset to the classification model, and wherein the first output comprises a first evaluation of user activity of the first user; generating, according to transformation criteria, a first plurality of datasets, wherein the first plurality of datasets comprises representations, in a second data format different from the first data format, of the first dataset and a second plurality of datasets corresponding to a plurality of users; based on providing each dataset of the first plurality of datasets to the classification model, generating a plurality of outputs, wherein each output of the plurality of outputs comprises a corresponding evaluation of corresponding user activity of a corresponding user of the plurality of users; based on providing the first plurality of datasets and the plurality of outputs to a second validation model, generating a second validation metric; based on comparing the first validation metric with the second validation metric, generating an evaluation metric of the first validation model with respect to the second validation model; based on the evaluation metric, generating a plurality of updated model parameters for the first validation model; generating an updated first validation model based on the plurality of updated model parameters; and training the classification model to output updated user evaluations based on a third validation metric generated by the updated first validation model.
2. A method comprising: receiving a first dataset, wherein the first dataset comprises information in a first data format corresponding to a first user; providing the first dataset and first output to a first validation model in order to generate a first validation metric, wherein the first output is generated by providing the first dataset to a classification model, and wherein the first output comprises first evaluation data associated with the first user; generating a first plurality of datasets, wherein the first plurality of datasets comprises representations of the first dataset in a second data format and a second plurality of datasets corresponding to a plurality of users; generating, from the classification model, a plurality of outputs based on the first plurality of datasets, wherein each output of the plurality of outputs comprises corresponding data of a corresponding user of the plurality of users; providing the first plurality of datasets and the plurality of outputs to a second validation model; based on the second validation model, generating a second validation metric; generating an evaluation metric of the first validation model with respect to the second validation model based on a comparison between the first validation metric and the second validation metric; based on the evaluation metric, generating a plurality of updated model parameters for the first validation model; and generating an updated first validation model based on the plurality of updated model parameters.
3. A method comprising: receiving a first dataset, wherein the first dataset comprises information in a first data format corresponding to a first user; based on providing the first dataset and first output to a first validation model, generating a first validation metric for a classification model, wherein the first output is generated based on providing the first dataset to the classification model, and wherein the first output comprises a first evaluation of the first user; generating, according to transformation criteria, a first plurality of datasets, wherein the first plurality of datasets comprises representations, in a second data format, of the first dataset and a second plurality of datasets corresponding to a plurality of users; based on providing each dataset of the first plurality of datasets to the classification model, generating a plurality of outputs, wherein each output of the plurality of outputs comprises a corresponding evaluation of a corresponding user of the plurality of users; based on providing the first plurality of datasets and the plurality of outputs to a second validation model, generating a second validation metric; generating an evaluation metric of the first validation model with respect to the second validation model; generating an updated first validation model based on the evaluation metric; and training the classification model to output updated evaluation data based on a third validation metric generated by the updated first validation model.
4. The method of any one of the preceding embodiments, wherein generating the first validation metric for the classification model comprises: determining first user activity data from the first dataset, wherein the first user activity data includes information characterizing activities by the first user; providing the first user activity data to the classification model, wherein the classification model is an artificial neural network-based decision-making model; based on providing the first user activity data to the classification model, generating the first output, wherein the first output indicates a first predicted user permission; and generating the first validation metric based on the first predicted user permission.
5. The method of any one of the preceding embodiments, wherein generating the first validation metric comprises: obtaining a first validation indicator for the first user, wherein the first validation indicator indicates a first determined user permission for the first user; and providing the first validation indicator, the first output, and the first user activity data to the first validation model to generate the first validation metric.
6. The method of any one of the preceding embodiments, wherein generating the first validation metric comprises: determining a match between the first determined user permission and the first predicted user permission; obtaining prior validation data for the classification model, wherein the prior validation data includes indications of matches between determined user permissions and predicted user permissions for a set of datasets, wherein the set of datasets includes a pre-determined number of datasets previously provided to the classification model; based on the match and the prior validation data, updating a moving-average accuracy metric for the classification model; and determining the first validation metric based on the moving-average accuracy metric for the classification model.
7. The method of any one of the preceding embodiments, wherein generating the first plurality of datasets comprises: determining a set of values for the first dataset, wherein the set of values includes values associated with a set of variables within the first dataset; modifying the set of values to generate a modified set of values associated with a modified set of variables; and generating a first representation of the first dataset in the second data format based on the modified set of values.
8. The method of any one of the preceding embodiments, wherein modifying the set of values to generate the modified set of values comprises: determining a first value corresponding to a first variable in the first dataset; generating a second value and a third value, wherein the first value comprises the second value and the third value, wherein the second value is associated with a second variable, and wherein the third value is associated with a third variable; generating the modified set of values to include the second value and the third value; and generating the modified set of variables to include the second variable and the third variable.
9. The method of any one of the preceding embodiments, wherein modifying the set of values to generate the modified set of values comprises: generating a plurality of validation statuses for the set of values, wherein each validation status for the set of values indicates a validity of a corresponding value of the set of values for a corresponding variable of the set of variables; generating a set of validated values corresponding to a set of validated variables, wherein each validated value of the set of validated values indicates a corresponding valid value of the set of values; and generating the modified set of values to include the set of validated values.
10. The method of any one of the preceding embodiments, wherein generating the first plurality of datasets comprises: obtaining a specification for the second data format, wherein the specification indicates format requirements for the second data format and security requirements for the second data format; and generating a first representation of the first dataset in the second data format to include data satisfying the format requirements and the security requirements.
11. The method of any one of the preceding embodiments, wherein providing the first dataset to the classification model comprises: determining a real-time classification model, wherein the real-time classification model is configured to accept datasets of the first data format without modification; determining that the first dataset includes missing values or erroneous values; providing the first dataset to the real-time classification model; and generating the first output based on providing the first dataset to the real-time classification model.
12. The method of any one of the preceding embodiments, wherein generating the plurality of outputs comprises: determining a batch classification model, wherein the batch classification model is configured to accept datasets of the second data format; detecting that a second dataset of the second plurality of datasets includes data inconsistent with the second data format; and generating, for display in a user interface of a user device, an error message, wherein the error message indicates that the second dataset is of an invalid data format for the batch classification model.
13. The method of any one of the preceding embodiments, wherein generating the second validation metric comprises: receiving a validation dataset, wherein the validation dataset includes a plurality of validation indicators, wherein each validation indicator of the plurality of validation indicators indicates a corresponding determined user permission for a corresponding dataset of the first plurality of datasets; comparing each validation indicator of the plurality of validation indicators with a corresponding output of the plurality of outputs; based on comparing each validation indicator of the plurality of validation indicators with the corresponding output of the plurality of outputs, generating a percentage match, wherein the plurality of outputs includes a plurality of predicted user permissions corresponding to the plurality of users, and wherein the percentage match indicates a fraction of validation indicators of the plurality of validation indicators that are consistent with corresponding outputs of the plurality of outputs; and generating the second validation metric to include the percentage match.
14. The method of any one of the preceding embodiments, further comprising: receiving a third plurality of datasets corresponding to a plurality of validated users; receiving a validation dataset, wherein the validation dataset includes a plurality of validation indicators, and wherein each validation indicator of the plurality of validation indicators indicates a corresponding determined user permission for a corresponding dataset of the third plurality of datasets; providing the third plurality of datasets and the validation dataset to the classification model; and based on providing the third plurality of datasets and the validation dataset to the classification model, training the classification model to predict user permissions for users as output.
15. The method of any one of the preceding embodiments, wherein providing the first dataset and the first output to the first validation model comprises: providing the first dataset and the first output to a machine learning model, wherein the machine learning model is a model configured to generate user evaluation metrics based on user data; generating a user evaluation status for the first user as output based on providing the first dataset and the first output to the machine learning model; and providing the first dataset and the user evaluation status to the first validation model.
16. The method of any one of the preceding embodiments, further comprising: retrieving a second dataset corresponding to a second user; providing the second dataset to the classification model to generate second output; providing the second dataset and the second output to the updated first validation model to generate a third validation metric; providing the third validation metric and the second dataset to the classification model; and based on providing the third validation metric and the second dataset to the classification model, training the classification model to generate evaluation data for users.
17. The method of any one of the preceding embodiments, further comprising: receiving a third dataset from a user device, the third dataset associated with a third user; providing the third dataset to the classification model to generate third output; generating a user permission for the third user based on the third output; and generating the user permission for display on a user interface associated with the user device.
18. One or more non-transitory, computer-readable media storing instructions that, when executed by a data processing apparatus, cause the data processing apparatus to perform operations comprising those of any of embodiments 1-17.
19. A system comprising one or more processors; and memory storing instructions that, when executed by the processors, cause the one or more processors to effectuate operations comprising those of any of embodiments 1-17.
20. A system comprising means for performing any of embodiments 1-17.
21. A system comprising cloud-based circuitry for performing any of embodiments 1-17.

What is claimed is:

1. A system for iteratively updating dynamic model validation algorithms for machine learning-based classification models, the system comprising:
one or more processors; and
one or more non-transitory, computer-readable media storing instructions that, when executed by the one or more processors, cause operations comprising:
receiving a first dataset, wherein the first dataset comprises information in a first data format corresponding to a first user;
based on providing the first dataset and first output to a first validation model, generating a first validation metric for a classification model, wherein the first output is generated based on providing the first dataset to the classification model, and wherein the first output comprises a first evaluation of user activity of the first user;
generating, according to transformation criteria, a first plurality of datasets, wherein the first plurality of datasets comprises representations, in a second data format different from the first data format, of the first dataset and a second plurality of datasets corresponding to a plurality of users;
based on providing each dataset of the first plurality of datasets to the classification model, generating a plurality of outputs, wherein each output of the plurality of outputs comprises a corresponding evaluation of corresponding user activity of a corresponding user of the plurality of users;
based on providing the first plurality of datasets and the plurality of outputs to a second validation model, generating a second validation metric;
based on comparing the first validation metric with the second validation metric, generating an evaluation metric of the first validation model with respect to the second validation model;
based on the evaluation metric, generating a plurality of updated model parameters for the first validation model;
generating an updated first validation model based on the plurality of updated model parameters; and
training the classification model to output updated user evaluations based on a third validation metric generated by the updated first validation model.

2. A method for updating validation algorithms for machine learning-based classification models, the method comprising:
receiving a first dataset, wherein the first dataset comprises information in a first data format corresponding to a first user;
providing the first dataset and first output to a first validation model in order to generate a first validation metric, wherein the first output is generated by providing the first dataset to a classification model, and wherein the first output comprises first evaluation data associated with the first user;
generating a first plurality of datasets, wherein the first plurality of datasets comprises representations of the first dataset in a second data format and a second plurality of datasets corresponding to a plurality of users;
generating, from the classification model, a plurality of outputs based on the first plurality of datasets, wherein each output of the plurality of outputs comprises corresponding data of a corresponding user of the plurality of users;
providing the first plurality of datasets and the plurality of outputs to a second validation model;
based on the second validation model, generating a second validation metric;
generating an evaluation metric of the first validation model with respect to the second validation model based on a comparison between the first validation metric and the second validation metric;
based on the evaluation metric, generating a plurality of updated model parameters for the first validation model; and
generating an updated first validation model based on the plurality of updated model parameters.

3. The method of claim 2, wherein generating the first validation metric comprises:
determining first user activity data from the first dataset, wherein the first user activity data includes information characterizing activities by the first user;
providing the first user activity data to the classification model, wherein the classification model is an artificial neural network-based decision-making model;
based on providing the first user activity data to the classification model, generating the first output, wherein the first output indicates a first predicted user permission; and
generating the first validation metric based on the first predicted user permission.

4. The method of claim 3, wherein generating the first validation metric comprises:
obtaining a first validation indicator for the first user, wherein the first validation indicator indicates a first determined user permission for the first user; and
providing the first validation indicator, the first output, and the first user activity data to the first validation model to generate the first validation metric.

5. The method of claim 4, wherein generating the first validation metric comprises:
determining a match between the first determined user permission and the first predicted user permission;
obtaining prior validation data for the classification model, wherein the prior validation data includes indications of matches between determined user permissions and predicted user permissions for a set of datasets, wherein the set of datasets includes a pre-determined number of datasets previously provided to the classification model;
based on the match and the prior validation data, updating a moving-average accuracy metric for the classification model; and
determining the first validation metric based on the moving-average accuracy metric for the classification model.

6. The method of claim 2, wherein generating the first plurality of datasets comprises:
determining a set of values for the first dataset, wherein the set of values includes values associated with a set of variables within the first dataset;
modifying the set of values to generate a modified set of values associated with a modified set of variables; and
generating a first representation of the first dataset in the second data format based on the modified set of values.

7. The method of claim 6, wherein modifying the set of values to generate the modified set of values comprises:
determining a first value corresponding to a first variable in the first dataset;
generating a second value and a third value, wherein the first value comprises the second value and the third value, wherein the second value is associated with a second variable, and wherein the third value is associated with a third variable;
generating the modified set of values to include the second value and the third value; and
generating the modified set of variables to include the second variable and the third variable.

8. The method of claim 6, wherein modifying the set of values to generate the modified set of values comprises:
generating a plurality of validation statuses for the set of values, wherein each validation status of the set of values indicates a validity of a corresponding value of the set of values for a corresponding variable of the set of variables;
generating a set of validated values corresponding to a set of validated variables, wherein each validated value of the set of validated values indicates a corresponding valid value of the set of values; and
generating the modified set of values to include the set of validated values.

9. The method of claim 2, wherein generating the first plurality of datasets comprises:
obtaining a specification for the second data format, wherein the specification indicates format requirements for the second data format and security requirements for the second data format; and
generating a first representation of the first dataset in the second data format to include data satisfying the format requirements and the security requirements.

10. The method of claim 2, wherein providing the first dataset to the classification model comprises:
determining a real-time classification model, wherein the real-time classification model is configured to accept datasets of the first data format without modification;
determining that the first dataset includes missing values or erroneous values;
providing the first dataset to the real-time classification model; and
generating the first output based on providing the first dataset to the real-time classification model.

11. The method of claim 2, wherein generating the plurality of outputs comprises:
determining a batch classification model, wherein the batch classification model is configured to accept datasets of the second data format;
detecting that a second dataset of the second plurality of datasets includes data inconsistent with the second data format; and
generating, for display in a user interface of a user device, an error message, wherein the error message indicates that the second dataset is of an invalid data format for the batch classification model.

12. The method of claim 2, wherein generating the second validation metric comprises:
receiving a validation dataset, wherein the validation dataset includes a plurality of validation indicators, wherein each validation indicator of the plurality of validation indicators indicates a corresponding determined user permission for a corresponding dataset of the first plurality of datasets;
comparing each validation indicator of the plurality of validation indicators with a corresponding output of the plurality of outputs;
based on comparing each validation indicator of the plurality of validation indicators with the corresponding output of the plurality of outputs, generating a percentage match, wherein the plurality of outputs includes a plurality of predicted user permissions corresponding to the plurality of users, and wherein the percentage match indicates a fraction of validation indicators of the plurality of validation indicators that are consistent with corresponding outputs of the plurality of outputs; and
generating the second validation metric to include the percentage match.

13. The method of claim 2, further comprising:
receiving a third plurality of datasets corresponding to a plurality of validated users;
receiving a validation dataset, wherein the validation dataset includes a plurality of validation indicators, wherein each validation indicator of the plurality of validation indicators indicates a corresponding determined user permission for a corresponding dataset of the third plurality of datasets;
providing the third plurality of datasets and the validation dataset to the classification model; and
based on providing the third plurality of datasets and the validation dataset to the classification model, training the classification model to predict user permissions for users as output.

14. The method of claim 2, wherein providing the first dataset and the first output to the first validation model comprises:
providing the first dataset to a machine learning model, wherein the machine learning model is a model configured to generate user evaluation metrics based on user data;
generating a user evaluation status for the first user as output based on providing the first dataset to the machine learning model; and
providing the first dataset and the user evaluation status to the first validation model.

15. The method of claim 2, further comprising:
retrieving a second dataset corresponding to a second user;
providing the second dataset to the classification model to generate second output;
providing the second dataset and the second output to the updated first validation model to generate a third validation metric;
providing the third validation metric and the second dataset to the classification model; and
based on providing the third validation metric and the second dataset to the classification model, training the classification model to generate evaluation data for users.

16. The method of claim 14, further comprising:
receiving a third dataset from a user device, the third dataset associated with a third user;
providing the third dataset to the classification model to generate third output;
generating a user permission for the third user based on the third output; and
generating the user permission for display on a user interface associated with the user device.

17. One or more non-transitory, computer-readable media storing instructions that, when executed by one or more processors, cause operations comprising:
receiving a first dataset, wherein the first dataset comprises information in a first data format corresponding to a first user;
based on providing the first dataset and first output to a first validation model, generating a first validation metric for a classification model, wherein the first output is generated based on providing the first dataset to the classification model, and wherein the first output comprises a first evaluation of the first user;
generating, according to transformation criteria, a first plurality of datasets, wherein the first plurality of datasets comprises representations, in a second data format, of the first dataset and a second plurality of datasets corresponding to a plurality of users;
based on providing each dataset of the first plurality of datasets to the classification model, generating a plurality of outputs, wherein each output of the plurality of outputs comprises a corresponding evaluation of a corresponding user of the plurality of users;
based on providing the first plurality of datasets and the plurality of outputs to a second validation model, generating a second validation metric;
generating an evaluation metric of the first validation model with respect to the second validation model;
generating an updated first validation model based on the evaluation metric; and
training the classification model to output updated evaluation data based on a third validation metric generated by the updated first validation model.

18. The one or more non-transitory, computer-readable media of claim 17, wherein generating the first validation metric for the classification model comprises:
determining first user activity data from the first dataset, wherein the first user activity data includes information characterizing activities by the first user;
providing the first user activity data to the classification model, wherein the classification model is an artificial neural network-based decision-making model;
based on providing the first user activity data to the classification model, generating the first output, wherein the first output indicates a first predicted user permission; and
generating the first validation metric based on the first predicted user permission.

19. The one or more non-transitory, computer-readable media of claim 18, wherein generating the first validation metric based on the first predicted user permission comprises:
obtaining a first validation indicator for the first user, wherein the first validation indicator indicates a first determined user permission for the first user; and
providing the first validation indicator, the first output, and the first user activity data to the first validation model to generate the first validation metric.

20. The one or more non-transitory, computer-readable media of claim 19, wherein generating the first validation metric for the classification model comprises:
determining a match between the first determined user permission and the first predicted user permission;
obtaining prior validation data for the classification model, wherein the prior validation data includes indications of matches between determined user permissions and predicted user permissions for a set of datasets, and wherein the set of datasets includes a pre-determined number of datasets previously provided to the classification model;
based on the match and the prior validation data, updating a moving-average accuracy metric for the classification model; and
determining the first validation metric based on the moving-average accuracy metric for the classification model.
